(19) United States
(12) Patent Application Publication
(10) Pub. No.: US 2019/0355074 A1
(43) Pub. Date: Nov. 21, 2019

(54) SYSTEMS, METHODS AND APPARATUS FOR LOCATION-BASED GOODS AND SERVICES PROCUREMENT

(71) Applicant: Tango Travel, LLC, West Chester, OH (US)

(72) Inventors: Robert Michael Schwartz, West Chester, OH (US); Thomas John Rodenkirch, Cincinnati, OH (US)

(21) Appl. No.: 16/414,908

(22) Filed: May 17, 2019

Related U.S. Application Data
(60) Provisional application No. 62/674,558, filed on May 21, 2018.

(51) Int. Cl. G06Q 50/12; G06Q 50/14; G06Q 10/02; H04W 4/021

(52) U.S. Cl. CPC G06Q 50/12; H04W 4/021; G06Q 10/02; G06Q 50/14

(57) ABSTRACT

Systems and methods for matching a traveler with a variety of goods and services based on their real-time location and their profile are provided. For the travel/hospitality industry, for example, one or more hotels can be suggested to a traveler in real-time by a goods and services procurement computing system based on their real-time location and travel preferences. Based on the response received from the traveler, the goods and services procurement computing system can book the hotel on behalf of the traveler.

### CROSS-REFERENCE TO RELATED APPLICATIONS

This application claims the benefit of U.S. application No. 62/674,558, filed May 21, 2018, and entitled SYSTEMS, METHODS AND APPARATUS FOR LOCATION-BASED GOODS AND SERVICES PROCUREMENT, the disclosure of which is incorporated herein by reference in its entirety.

### BACKGROUND

Online hotel booking methods have taken basic, historical reservation practices and ported them into online systems. While such online systems seemingly provide travelers with a plethora of booking options, navigating such online systems is becoming increasingly more complicated and cumbersome, and at times confusing. Further, despite consulting numerous online systems in an attempt to book a hotel, the traveler may not be able to readily identify the hotel property that is best suited for their needs due, at least in part, to the number of results in their searching and the variety of amenities offered at each property. Further, the search parameters provided to the traveler are typically limited to binary search options. Ultimately, a traveler may simply decide to make a decision based on a price, for instance, in an attempt to simplify the process, thereby ignoring other factors that may have importance to them.

For travelers wishing to book a hotel after they are already in-transit is even more difficult. Whether their ultimate destination is known or not, most travelers do not want to try and navigate one or more online booking websites while driving. While in these circumstances the traveler could potentially pull of the road and attempt to perform online searches via a mobile device, such searching can be challenging and still suffers from all of the previously mentioned deficiencies in the process.

Consequently, it would be beneficial to provide improvements to the hotel booking process, as well as other improvements related to the procurement of other types of goods and services.

### BRIEF DESCRIPTION OF THE DRAWINGS

Embodiments of the present invention are illustrated by way of example and not limitation in the figures of the accompanying drawings, in which like references indicate similar elements and in which:

FIG. 1 depicts an example goods and services procurement computing system in accordance with one non-limiting embodiment.

FIG. 2 schematically depicts the building of an example traveler profile for use by an goods and services procurement computing system in accordance with one non-limiting embodiment.

FIG. 3 schematically depicts a trip plan for a traveler and the traveler's preferences based on the completion of the traveler profile shown in FIG. 2 in accordance with one non-limiting embodiment.

FIGS. 4-5 depicts a grid is applied to a geographic region of interest, which is shown as the continental United States for the purposes of illustration.

FIG. 6 depicts the identification of geolocation information of hotel chain properties of a particular region.

FIGS. 7-8 schematically depicts an example tracking of a journey traveler.

FIGS. 9-10 depicts an example current position of traveler with GPS coordinates for the traveler being tracked and logged by a goods and services procurement computing system.

FIGS. 11-12 depict an example overlay of a predicted travel cone once a certain coefficient of variation bearing has been achieved.

FIGS. 13-14 depicts an example use of web services to determine a travel path from a map point to the current road of travel.

FIG. 15 depicts the example logging of downstream coordinates for a map point.

FIG. 16 illustrates a travel path from a map point to a current road of travel.

FIG. 17 schematically depicts the predicted heading for the traveler using the downstream coordinates for the current road of travel.

FIG. 18 depicts the relevant grids within which each of the downstream coordinates shown in FIG. 17 are found.

FIGS. 19-20 depicts the determination that a downstream coordinate is within a certain threshold distance from the perimeter of the Region 22-12.

FIG. 21 depicts the determination that Regions 23-11, 24-11, 25-11, 22-12, and 23-12 are pertinent to the example journey traveler.

FIGS. 22A-22B identifies the sixteen hotels that are closest to the current road of travel/

FIGS. 23A-23B depict example data computed for each of the hotels using data from various sources.

FIG. 24 depicts the identification of the nearest street from an example hotel.

FIG. 25 schematically illustrates a distance as measured by a webservice.

FIG. 26 depicts an example process flow diagram of processing performed by a goods and services procurement computing system for a destination traveler in accordance with one non-limiting embodiment.

FIG. 27 depicts an example process flow diagram of processing performed by a goods and services procurement computing system for a journey traveler in accordance with one non-limiting embodiment.

### DETAILED DESCRIPTION

Various non-limiting embodiments of the present disclosure will now be described to provide an overall understanding of the principles of the structure, function, and use of goods and services procurement systems and methods disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures, or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term software is used expansively to include not only executable code, but also data structures, data stores, and computing instructions in any electronic format, firmware, and embedded software. The terms information and data are used expansively and can include a wide variety of electronic information, including but not limited to machine-executable or machine-interpretable instructions; content such as text, video data, and audio data, among others; and various codes or flags. The terms information, data, and content are sometimes used interchangeably when permitted by context.

The examples discussed herein are examples only and are provided to assist in the explanation of the systems and methods described herein. None of the features or components shown in the drawings or discussed below should be taken as mandatory for any specific implementation of any of these systems and methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As is to be appreciated, the presently disclosed systems and methods can be implemented in a variety of environments, industries, and applications. One example industry is the travel/hospitality industry. This disclosure, however, is not so limited. For instance, the travelers in the market for a certain vehicle can be alerted when they are traveling in proximity to a vehicle that is for sale that meets, or at least closely meets, certain user-defined characteristics. Moreover, providers of such goods and services, such as car dealers, can be alerted when a traveler is in proximity that is desiring to acquire certain goods and services. Thus, the goods and services procurement platform in accordance with the present disclosure can be used in a variety of operational environments. Although the disclosure below is described largely in the context of a hospitality industry operational environment, this example operational environment is merely for illustrative purposes and is not intended to be limiting.

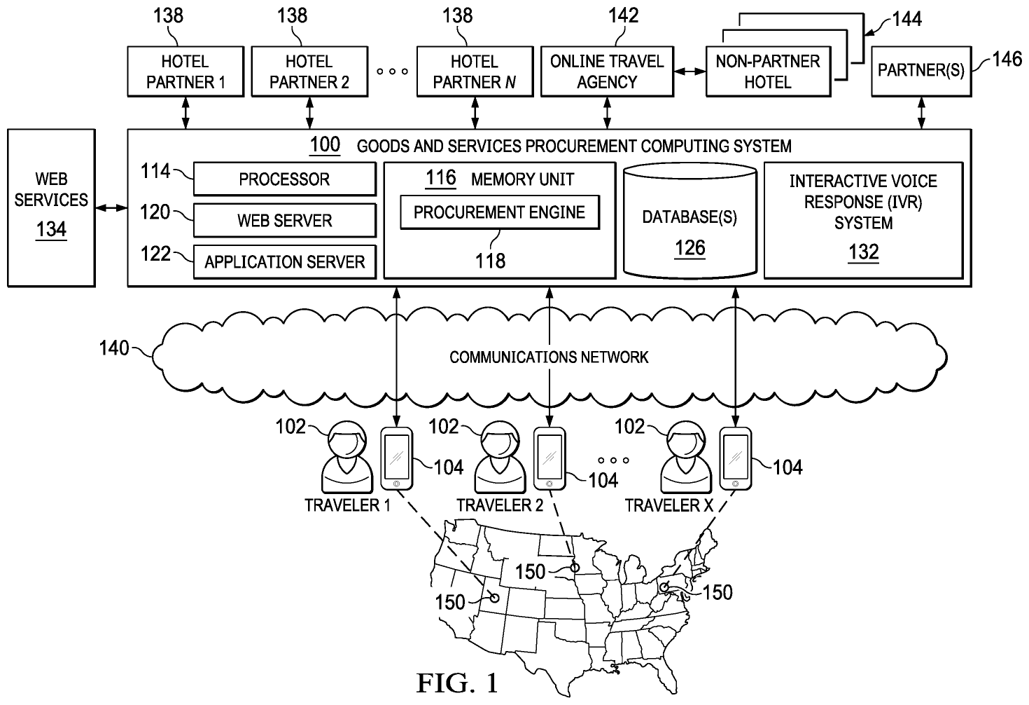

Referring now to FIG. 1, one example embodiment of the present disclosure can comprise a goods and services procurement computing system 100. The goods and services procurement computing system 100 can be provided using any suitable processor-based device or system, such as a personal computer, laptop, server, mainframe, or a collection (e.g., network) of multiple computers, for example. The goods and services procurement computing system 100 can include one or more processors 114 and one or more computer memory units 116. For convenience, only one processor 114 and only one memory unit 116 are shown in FIG. 1. The processor 114 can execute software instructions stored on the memory unit 116. The processor 114 can be implemented as an integrated circuit (IC) having one or multiple cores. The memory unit 116 can include volatile and/or non-volatile memory units. Volatile memory units can include random access memory (RAM), for example. Non-volatile memory units can include read only memory (ROM), for example, as well as mechanical non-volatile memory systems, such as, for example, a hard disk drive, an optical disk drive, etc. The RAM and/or ROM memory units can be implemented as discrete memory ICs, for example.

The memory unit 116 can store executable software and data for a procurement engine 118. When the processor 114 of the goods and services procurement computing system 100 executes the software of the procurement engine 118, the processor 114 can be caused to perform the various operations of the goods and services procurement computing system 100, such as build traveler profiles, monitor travelers' positions; determine predictive travel behavior; match goods/services; provide communications to the traveler; and procure goods/services, as discussed in more detail below.

Data used by the procurement engine 118 can be from various sources, such as a database(s) 126, which can be electronic computer databases, for example. The data stored in the database(s) 126 can be stored in a non-volatile computer memory, such as a hard disk drive, a read only memory (e.g., a ROM IC), or other types of non-volatile memory. In some embodiments, one or more databases 126 can be stored on a remote electronic computer system, for example. As it to be appreciated, a variety of other databases, or other types of memory storage structures, can be utilized or otherwise associated with the goods and services procurement computing system 100. Further, additional information used by the procurement engine 118 can come from other data sources, such as various hotel partners 138, among other sources.

The goods and services procurement computing system 100 can be in communication with mobile communications devices 104 via an electronic communications network 140.The communications network can include a number of computer and/or data networks, including the Internet, LANs, WANs, GPRS networks, etc., and can comprise wired and/or wireless communication links. In addition to the mobile communications devices 104, the goods and services procurement computing system 100 can be in networked communication with other devices, such as a computing devices associated with various hotel partners 138. Through communications with the computer device of the hotel partners 138, the goods and services procurement computing system 100 can receive data regarding the respective hotel as well as, in some embodiments, book the hotel. The goods and services procurement computing system 100 can be in networked communication with other devices, such as computing devices associated with various online travel agencies (OTA) 142. The online travel agencies 142 can be in communication with various non-partner hotels 144. The goods and services procurement computing system 100 can be in networked communication with other devices, such as computing devices associated with various goods and services partners 146. Example goods and services partners 146 can include, without limitation, car dealerships, online car sales platforms, online marketplaces, and so forth. The present disclosure is not so limited to any particular type of partner, as a variety of partners or goods and/or services provider can leverage the capabilities of the goods and services procurement computing system 100 described herein.

Referring still to FIG. 1, a traveler 102 can be associated with the mobile communications device 104, which can be any type computer device suitable for communication over the network, such as a wearable computing device, a mobile telephone, a tablet computer, a device that is a combination handheld computer and mobile telephone (sometimes referred to as a “smart phone”), a personal computer (such as a laptop computer, netbook computer, desktop computer, and so forth), or any other suitable mobile communications device, such as personal digital assistants (PDA), mobile gaming devices, or media players, for example. Examples of wearable computing device (sometimes referred to as a “wearable”) include devices that incorporate an augmented reality head-mounted display as well as other computing devices that can be worn by the traveler 102.

In some example embodiments, the mobile communications device 104 can be arranged to perform data communications functionality in accordance with shorter range wireless networks, such as a wireless personal area network (PAN) offering Bluetooth® data communications services in accordance with the Bluetooth®. Special Interest Group (SIG) series of protocols, specifications, profiles, and so forth. Other examples of shorter range wireless networks can employ infrared (IR) techniques or near-field communication techniques and protocols, such as electromagnetic induction (EMI) techniques including passive or active radio-frequency identification (RFID) protocols and devices. Mobile communications device 104 can comprise one or more internal and/or external antennas to support operation in multiple frequency bands or sub-bands such as the 2.4 GHz range of the ISM frequency band for Wi-Fi and Bluetooth® communications, one or more of the 850 MHz, 900 MHZ, 1800 MHz, and 1900 MHz frequency bands for GSM, CDMA, TDMA, NAMPS, cellular, and/or PCS communications, the 2100 MHz frequency band for CDMA2000/EV-DO and/or WCDMA/JMTS communications, the 1575 MHz frequency band for Global Positioning System (GPS) operations, and others.

The mobile communications device 104 can, in some embodiments, provide a variety of applications for allowing the traveler 102 to accomplish one or more specific tasks using the goods and services procurement computing system 100. Applications can include, without limitation, a web browser application (e.g., INTERNET EXPLORER, MOZILLA, FIREFOX, SAFARI, OPERA, NETSCAPE NAVIGATOR) telephone application (e.g., cellular, VoIP, PTT), networking application, messaging application (e.g., e-mail, IM, SMS, MMS, BLACKBERRY Messenger), and so forth. The mobile communications device 104 can comprise various software programs such as system programs and applications to provide computing capabilities in accordance with the described embodiments. System programs can include, without limitation, an operating system (OS), device drivers, programming tools, utility programs, software libraries, application programming interfaces (APIs), and so forth. Exemplary operating systems can include, for example, a PALM OS, MICROSOFT OS, APPLE OS, ANDROID OS, UNIX OS, LINUX OS, SYMBIAN OS, EMBEDIX OS, Binary Run-time Environment for Wireless (BREW) OS, JavaOS, a Wireless Application Protocol (WAP) OS, and others.

The mobile communications device 104 can include various components for interacting with the goods and services procurement computing system 100. The mobile communications device 104 can include components for use with one or more applications such as a stylus, a touch-sensitive screen, keys (e.g., input keys, preset and programmable hot keys), buttons (e.g., action buttons, a multidirectional navigation button, preset and programmable shortcut buttons), switches, a microphone, speakers, an audio headset, and so forth.

The traveler 102 can interact with the goods and services procurement computing system 100 via a variety of other electronic communications techniques, such as, without limitation, HTTP requests, in-app messaging, and short message service (SMS) messages. The electronic communications can be generated by a specialized application executed on the mobile communications device 104 or can be generated using one or more applications that are generally standard to the mobile communications device 104. The applications can include or be implemented as executable computer program instructions stored on computer-readable storage media such as volatile or non-volatile memory capable of being retrieved and executed by a processor to provide operations for the mobile communications device 104. The memory can also store various databases and/or other types of data structures (e.g., arrays, files, tables, records) for storing data for use by the processor and/or other elements of mobile communications device 104.

As shown in FIG. 1, the goods and services procurement computing system 100 can include several computer servers and databases. For example, the goods and services procurement computing system 100 can include one or more web servers 120, application servers 122, and/or any other type of servers. For convenience, only one web server 120 and one application server 122 are shown in FIG. 1, although it should be recognized that the disclosure is not so limited. The servers can cause content to be sent to the to the mobile communication device 104 in any number of formats, such as text-based messages, multimedia message, email messages, smart phone notifications, phone calls, web pages, and so forth. The servers 120, 122 can comprise processors (e.g., CPUs), memory units (e.g., RAM, ROM), non-volatile storage systems (e.g., hard disk drive systems), etc. The servers 120, 122 can utilize operating systems, such as Solaris, Linux, or Windows Server operating systems, for example.

The web server 120 can provide a graphical web user interface through which various users of the system can interact with the goods and services procurement computing system 100. The web server 120 can accept requests, such as HTTP requests, from clients (such as web browsers on the mobile communications device 104 or the computing devices of the hotel partners 138), and serve the clients responses, such as HTTP responses, along with optional data content, such as web pages (e.g., HTML documents) and linked objects (such as images, video, and so forth).

The application server 122 can provide a user interface for users who do not communicate with the goods and services procurement computing system 100 using a web browser. Such users can have special software installed on their mobile communications device 104 that allows them to communicate with the application server 122 via the network. Such software can be downloaded, for example, from the goods and services procurement computing system 100, or other software application provider, over the network to such mobile communications devices 104.

In some embodiments, the goods and services procurement computing system 100 can include an interactive voice response (IVR) system 132. While FIG. 1 schematically depicts the IVR system 132 as being a component of the goods and services procurement computing system 100, it is to be appreciated that the IVR system 132 may be positioned remote from the goods and services procurement computing system 100, or even provided by a third party. In any event, the IVR system 132 can be utilized to place automated telephone calls to the traveler 102 to inform the traveler 102 of matched goods or services, and to receive instructions from the traveler 102, as described in more detail below. The goods and services procurement computing system 100 can also communicate with other systems, generally shown as web services 134, which can provide certain information or processing capabilities. For instance, various web services 134 may be utilized to provide various processing related to geolocation services.

As schematically depicted in FIG. 1, the real-time geolocation position 150 travelers 102 can be provided to the goods and services procurement computing system 100 by the mobile communications devices 104. The goods and services procurement computing system 100 can utilize the real-time geolocation position 150 to provide the various services to the traveler 102 described herein. In the context of hospitality services, the goods and services procurement computing system 100 can determine one or more hotels to suggest to the traveler 102. Such one or more hotels can be suggested to the traveler 102 by way of a telephone call placed to the mobile communications device 104 using the IVR 132. Based on the responses received from the traveler 102, the goods and services procurement computing system 100 can proceed to book one of the hotels, or perform additional searching/matching on behalf of the traveler 102.

The goods and services procurement computing system 100 in accordance with the present disclosure can provide various benefits to the hotel partners 138. For instance, the hotel partners 138 can leverage the goods and services procurement computing system 100 to fill unsold rooms at the “last minute” that would otherwise remain vacant. The goods and services procurement computing system 100 in accordance with the present disclosure can also provide various benefits to travelers 102. Since the goods and services procurement computing system 100 utilizes a traveler profile to determine which hotels to suggest to the traveler, the need for the traveler to conduct their own online search is eliminated. Additionally, the goods and services procurement computing system 100 can automatically place a call the traveler's device, eliminating the need for the traveler to pull off the road to complete the booking process. In some embodiments, booking a hotel through the goods and services procurement computing system 100 can allow the traveler to accumulate loyalty points. Moreover, certain hotel properties may allow the traveler 102 to bypass the check-in counter, as the physical location of the traveler 102 can be tracked such that it is known by the goods and services procurement computing system 100 once the traveler enters the premises of the hotel.

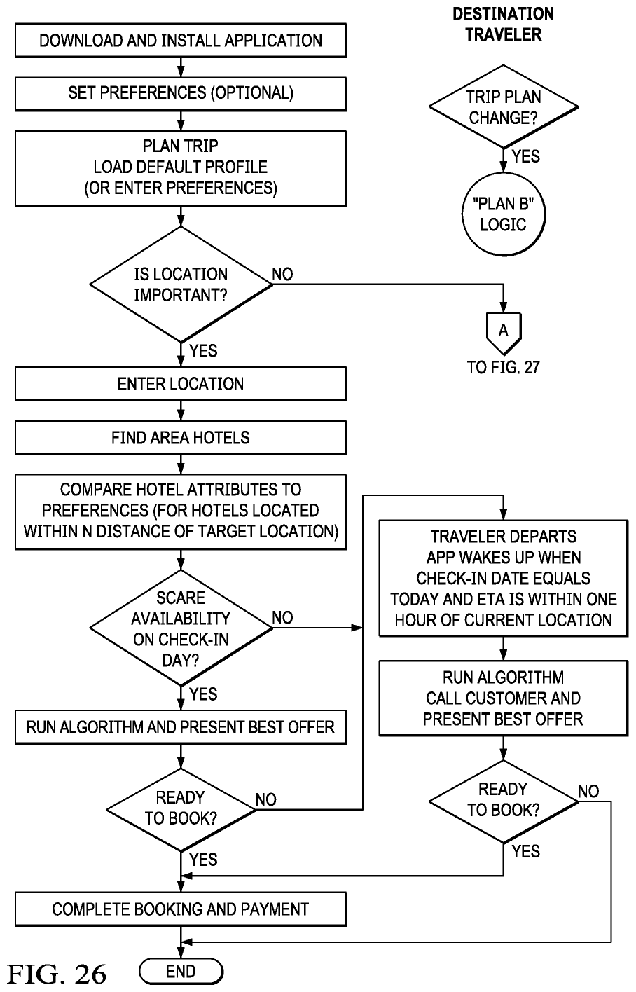

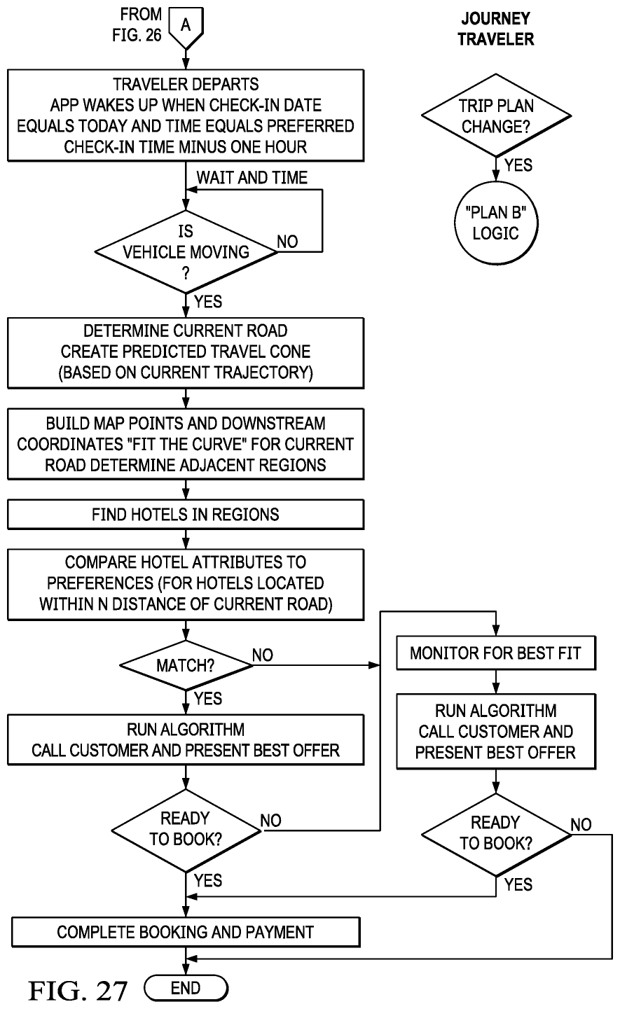

The goods and services procurement computing system 100 can be utilized by a variety of different types of travelers 102, including “journey” travelers and “destination” travelers, each of which may be driving or traveling via other means (i.e., air, train, boat, etc.). Journey travelers can generally be travelers that do not have a specific destination location in mind, but rather have a preferred stopping time (i.e., around 8 pm). Destination travelers, by comparison, have a destination in mind, such as a city or other point of interest. Depending on the type of traveler, the goods and services procurement computing system 100 can utilize different process flows, as shown below in FIGS. 26-27. For a journey traveler, the goods and services procurement computing system 100 may begin to determine which hotels are of interest based on the time of day and the time the traveler would like to check into a hotel. For a destination traveler, the goods and services procurement computing system 100 may begin to determine which hotels are of interest based on when the traveler is within a certain proximity to the destination point. In either instance, the traveler is automatically provided with one or more hotel options that suit their needs, without requiring the traveler to interact with their mobile communications device to perform an online search.

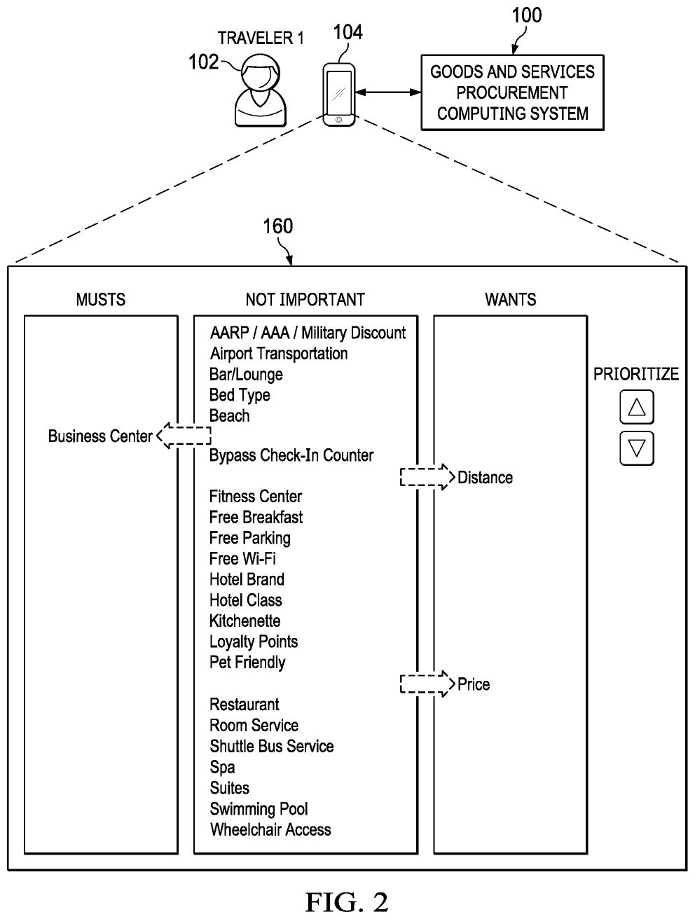

FIG. 2 schematically depicts the building of a traveler profile 160 for the traveler 102 for use by a goods and services procurement computing system 100. As illustrated, the traveler 102 can interact with an interface on the mobile communications device 104 to build the traveler profile 160. The traveler 102 can use any type of computing device that is in networked communication with the goods and services procurement computing system 100. The “drag and drop” traveler profile 160 depicted in FIG. 2 is merely an example interface. As is to be readily appreciated, the traveler profile 160 can be built using any of number of interfaces, which may include, without limitation, drop-down menus, radio buttons, and so forth. Further, the particular features and amenities identified in FIG. 2 are merely for illustration purposes. Other embodiments may include different amenities or features. For example, when building a traveler profile 160 in conjunction with the purchase of a vehicle, the features listing may include car-related aspects, and/or identify makes/models of specific vehicles.

Through any suitable type of interaction with the interface, the traveler 160 can quantify the importance of certain features/aspects of their lodging preferences (generally referred to herein as “attributes”). In the illustrated embodiment, the traveler 160 can identify certain attributes as “musts” and others as “wants.” Moreover, within the grouping of “wants”, the traveler can order the listing of attributes within the grouping such that they are ranked in order of preference. Depending on the type of traveler (i.e., journey vs. destination) certain attributes may impact the process differently. By way of example, the particular “distance” value provided by a traveler may be the maximum distance from a target location by a destination traveler and may be a maximum distance from the current road being traveled by the journey traveler.

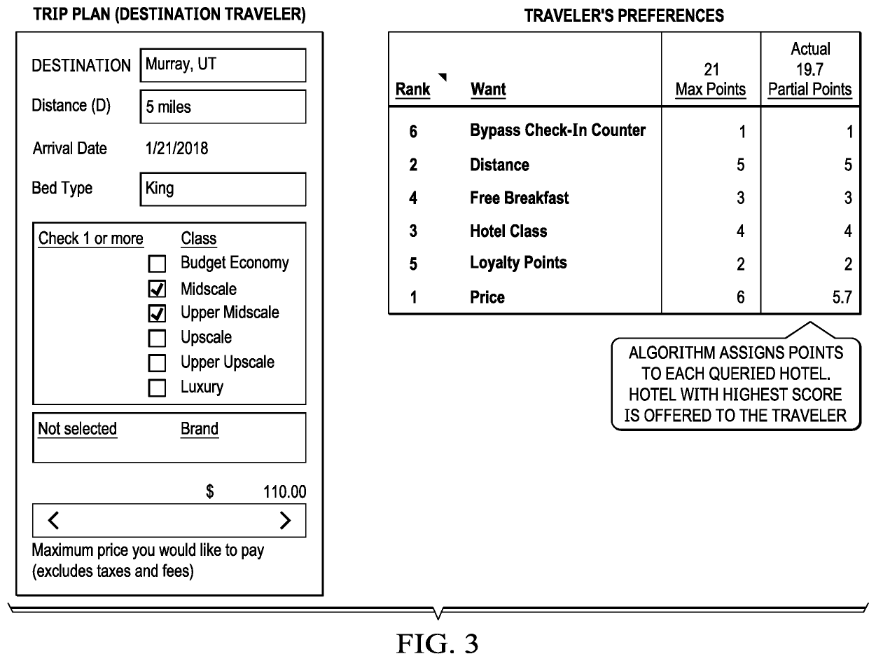

FIG. 3 schematically depicts a trip plan for a traveler 102 and the traveler's preferences based on the completion of the traveler profile 160 shown in FIG. 2. In the illustrated embodiment, the traveler identified six “wants” and ranked them accordingly. The goods and services procurement computing system 100 assigned each “want” with a point value such that the suitability of various hotels partners 138 (FIG. 1) to those “wants” can be automatically quantified. For the purposes of illustration, a trip plan for a destination traveler is schematically depicted in FIG. 3. As is to be appreciated, such trip plan details can be provided by the traveler 102 to the goods and services procurement computing system 100 through interactions with the mobile communications device 104, or otherwise. As the traveler 102 approaches the destination (shown as Murray, Utah), hotel partners 138 within the area can be queried by the goods and services procurement computing system 100 to check on availability, pricing, and so forth. In some embodiments, amenities offered by the hotel can be obtained at this time, or the amenities could have previously been ascertained by the goods and services procurement computing system 100 and stored within the database(s) 126, such as during a partner enrollment process. In any event, for each hotel satisfying all of the “musts,” the hotel can further be analyzed to determine a matching score based on the “wants” of the traveler 102. In one embodiment, as shown in FIG. 3, if a “want” is completely satisfied, that hotel is awarded a certain number of maximum points for that particular amenity. The amenities are weighted, such that higher priority “wants” are awarded with more points. If the hotel partially satisfies the “want,” then partial points can be awarded. The points for each hotel earned for each “want” can then be aggregated to obtain a total points score for that hotel. For hotels that result in the same total points, a suitable tie breaker can be automatically utilized by the goods and services procurement computing system 100, such as the hotel with the higher classification is given higher priority.

Once a matching hotel is identified, the IVR system 132 of the goods and services procurement computing system 100 can contact the mobile communications device 104 and verbally convey the information to the traveler 102. For the purposes of authentication, the IVR system 132 may require the traveler 102 provide a PIN number, or other form of identification. In some embodiments, the verbal communication provided by the IVR system 132 to the traveler 102 can identify the strength of the match, such as a “perfect match”, an “excellent match”, or a “good match.” If all of the traveler's wants are matched, it may be considered a perfect match. If a certain threshold of points is exceeded (i.e., greater than or equal to 81% of total maximum points), it may be considered an excellent match. If less than a certain threshold of points is achieved (i.e., less than 81% of total maximum points), it may be considered a good match. The traveler 102 can then respond to the IVR system 132 (either verbally or through the keypad) and decide whether to proceed with booking or to request additional options. Assuming the traveler 102 wants to book a room at the recommended hotel, the goods and services procurement computing system 100 can communicate with the relevant hotel partner 138 to complete the booking process. Notably, the traveler 102 is able to become aware of highly relevant hotels without needing to complete any type of “online search.”

It is noted that in some instances, the hotel partners 138 may not be available to the traveler 102. Such situation may occur when the traveler 102 is in an area with a limited supply of hotels, or they have a high number of “musts” that limit the number of hotels deemed to be acceptable. In such case, the goods and services procurement computing system 100 can communicate with a conventional online travel agency 142, which in turn, polls the availability of non-partner hotels 144 in the relevant geographic areas. A room at the non-partner hotel 144 can then be offered to the traveler 102.

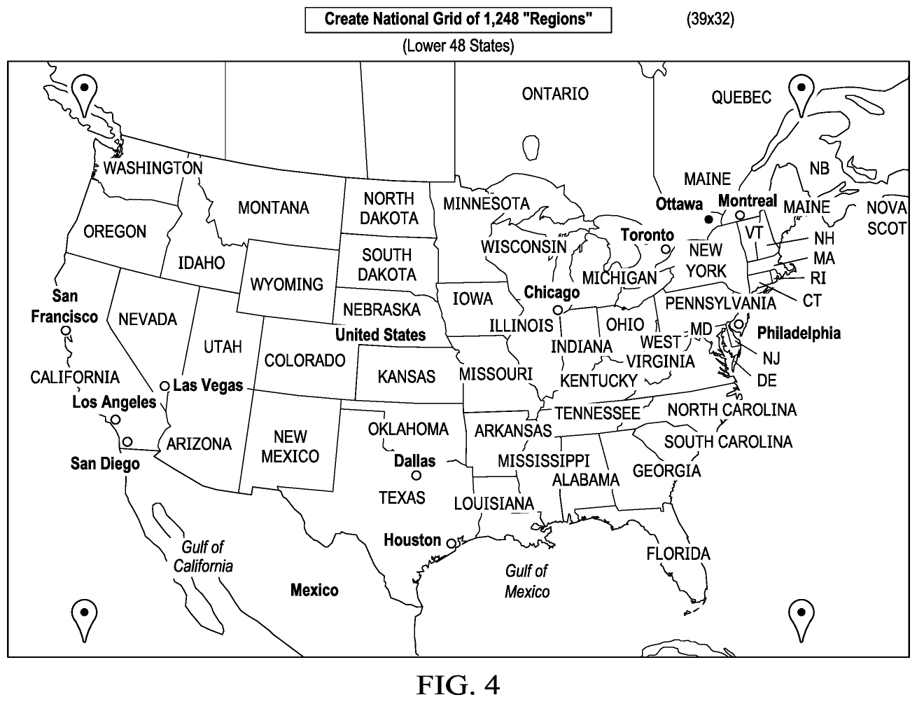

FIGS. 4-25 depict example processing utilized by the goods and services procurement computing system 100 to identify and quantify hotels of interest to a “journey” traveler 102. As described below, the identified hotel(s) are based on the traveler's real-time geolocation, predicted path of travel, and traveler profile 160 (FIG. 2). There are numerous challenges in predicting a traveler's route and location at a future point in time. While exits numbers and coordinates are published for Interstate highways, this is not the case for most U.S. highways and for State and County roads. Furthermore, roads curve; current heading is not a good predictor of actual heading on current road.

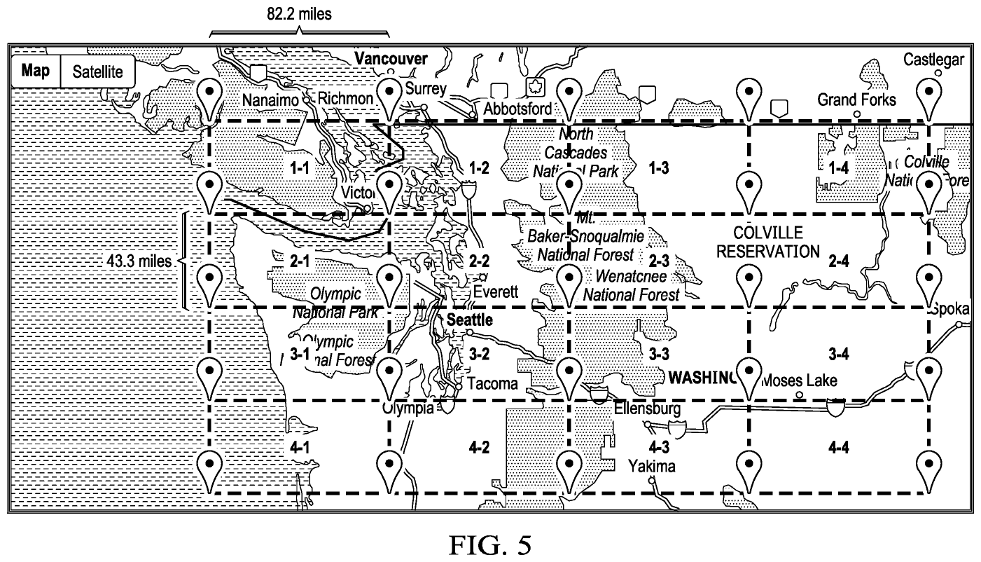

Referring first to FIG. 4, a grid is applied to a geographic region of interest, which is shown as the continental United States for the purposes of illustration. As shown in FIGS. 4-5, a grid of 1,248 regions are applied across the geographic region of interest. In the illustrated example, each region is 82.2 miles by 43.3 miles, although this disclosure is not so limited. The use of the grid is to aid in the speed of processing information by the goods and services procurement computing system 100, as certain regions of the grid can be deemed to be relevant for a particular traveler and the other regions can be ignored.

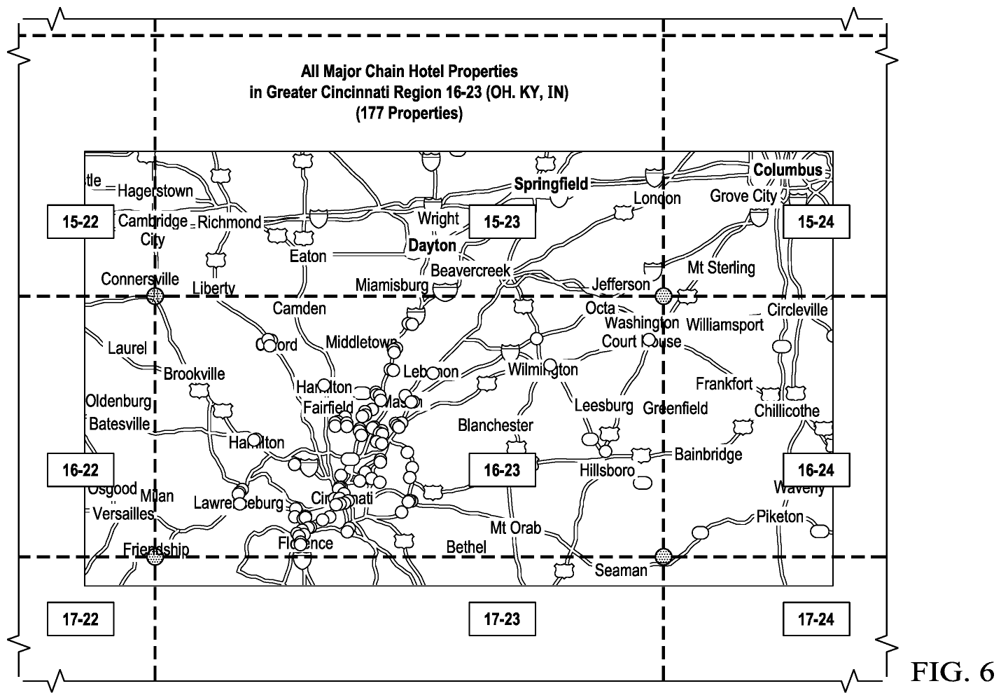

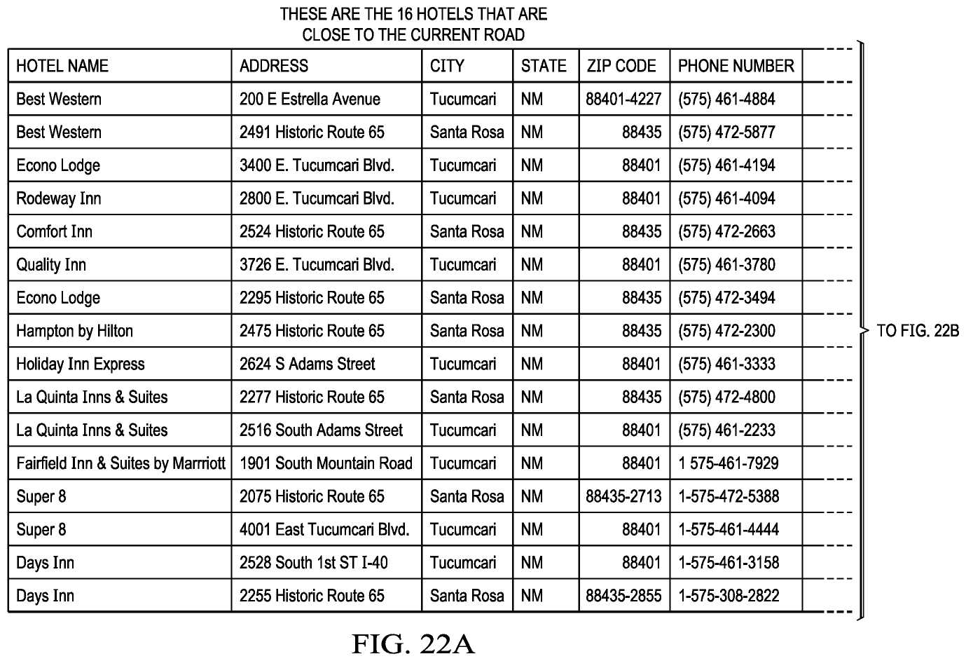

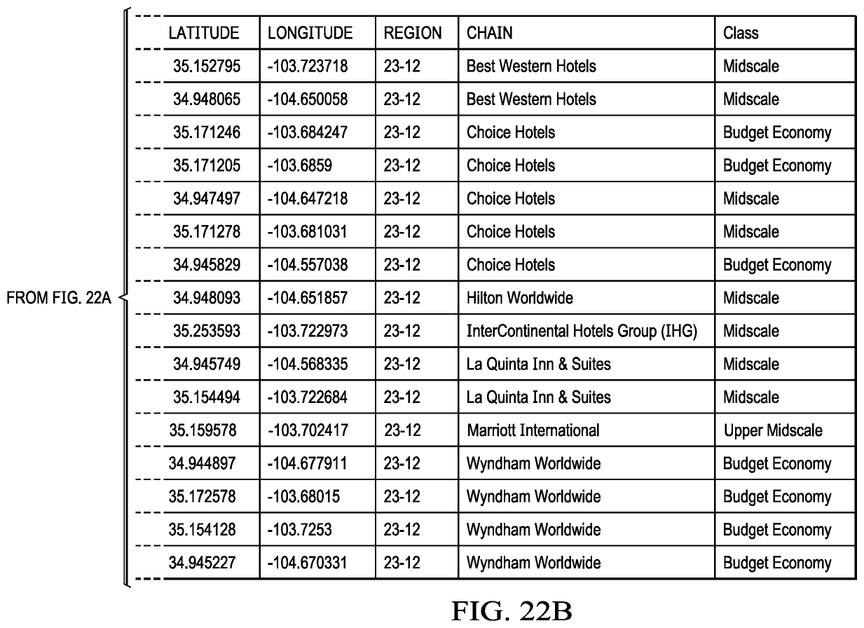

Referring to FIG. 6, the geolocation information of all of the major hotel chain properties of a particular region (shown as greater Cincinnati, Ohio) are identified. Such geolocation information can be stored by the goods and services procurement computing system 100 for each region of the grid. Along with geolocation information, other pertinent information can be stored by the goods and services procurement computing system 100 as well, such as hotel name, amenities, chain name, class, etc. (See e.g., FIG. 22, below).

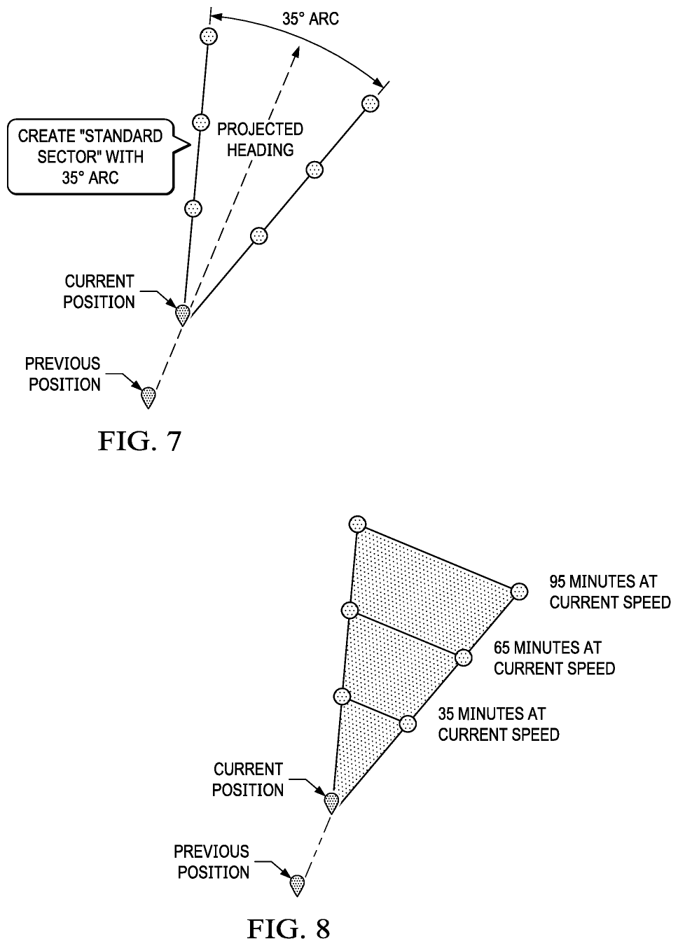

FIG. 7 schematically depicts the tracking of a “journey” traveler 102 by the goods and services procurement computing system 100. As the particular destination of a journey traveler 102 is not known by the goods and services procurement computing system 100, the location of the traveler 102 at a certain period of time in the future can be ascertained in accordance with the present disclosure based on the traveler's bearing and present location. Once the predicted destination is ascertained, the goods and services procurement computing system 100 can query the relevant hotel partners 138 for availability, pricing, etc. and then apply points to each based on the traveler profile, as described above.

Referring to FIGS. 7-8, in one example embodiment, the goods and services procurement computing system 100 can create a predicted travel cone for the traveler based on a current trajectory of the traveler. In the illustrated embodiment, the predicted travel cone has a 35 degree arc, although this disclosure is not so limited. The goods and services procurement computing system 100 can utilize an application web service, such those provided by “Geo Names” to identify the road on which the traveler is currently driving. Based on the traveler's rate of speed, the distance of travel within the predicted travel cone can be predicted by the goods and services procurement computing system 100, shown as travel bands. It is noted that these travel bands can be determined irrespective of available roadways. By way of example, FIG. 8 shows predicted distance of travel at 35 minutes, 65 minutes, and 95 minutes based on the traveler's current rate of speed. In some embodiments, the haversine formula is utilized to calculate various distances utilized by the goods and services procurement computing system 100. Generally, the goods and services procurement computing system 100 can utilize the haversine formula to calculate the distance between two points on the Earth's surface based on the points' longitude and latitude.

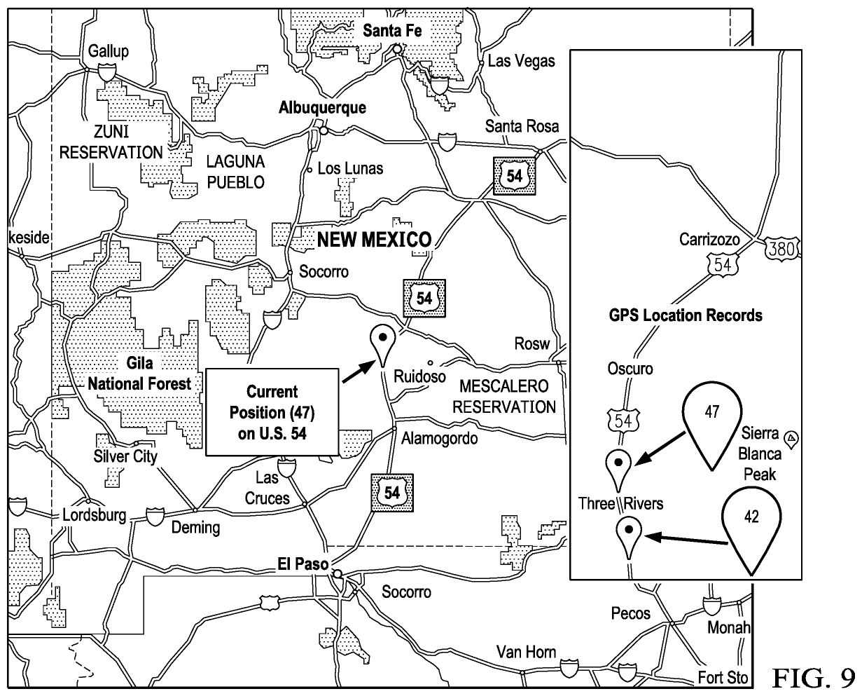

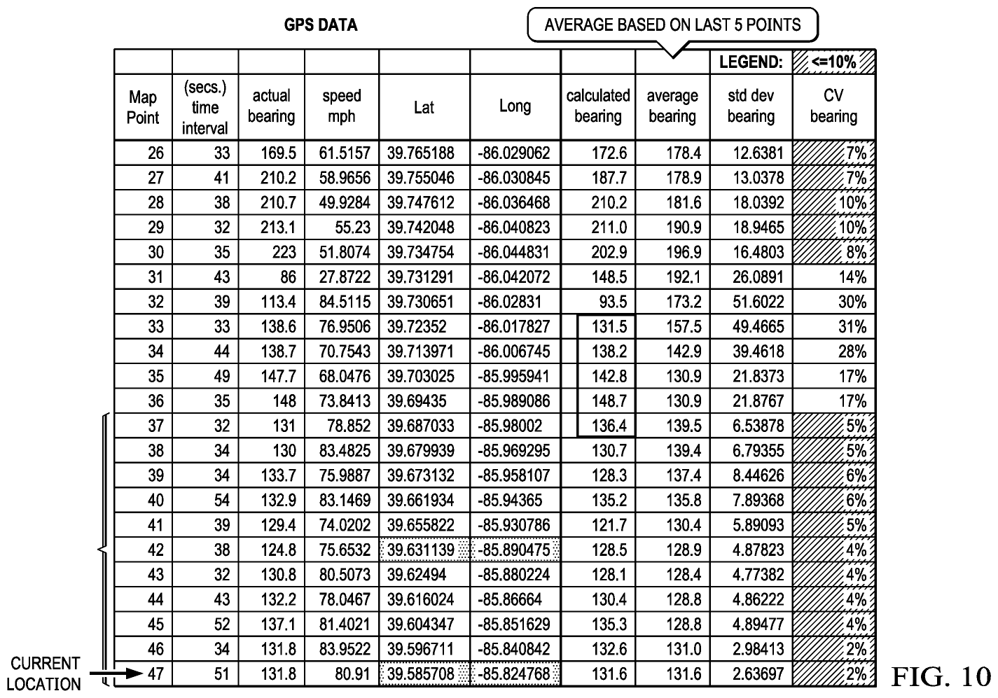

FIGS. 9-10 depicts an example current position of traveler 102 with the GPS coordinates for the traveler being tracked and logged by the goods and services procurement computing system 100. The GPS coordinates (FIG. 10) can be provided by the mobile communication device 104 to the goods and services procurement computing system 100 in substantially real-time. In one example embodiment, the coefficient of variation (CV) of the traveler's bearing can be used by the goods and services procurement computing system 100 to determine whether the traveler is generally traveling in a straight line.

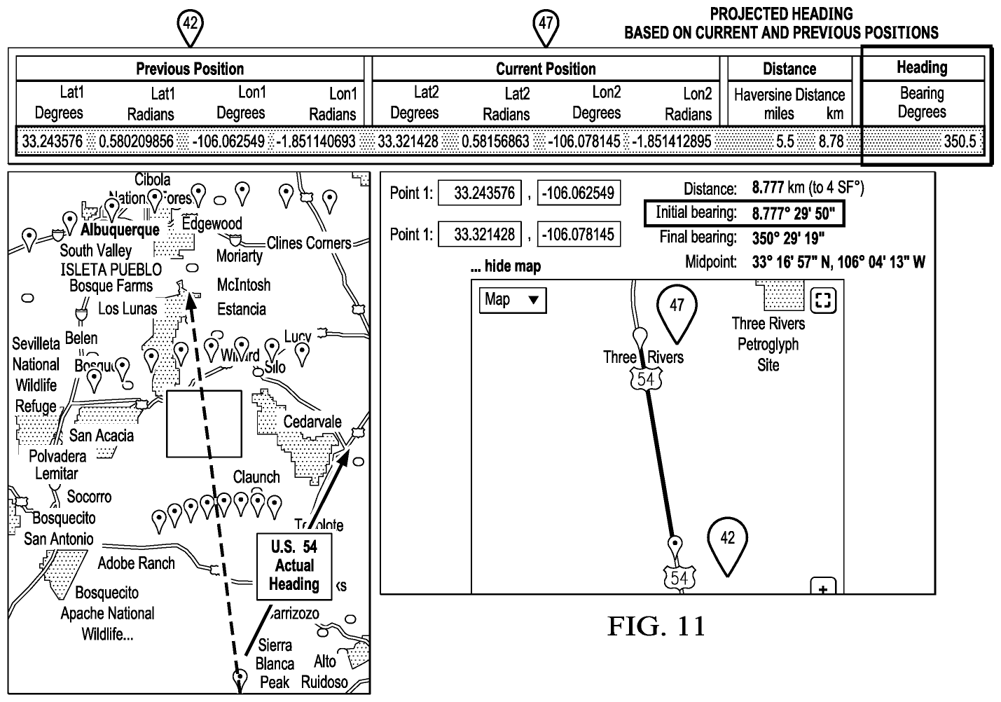

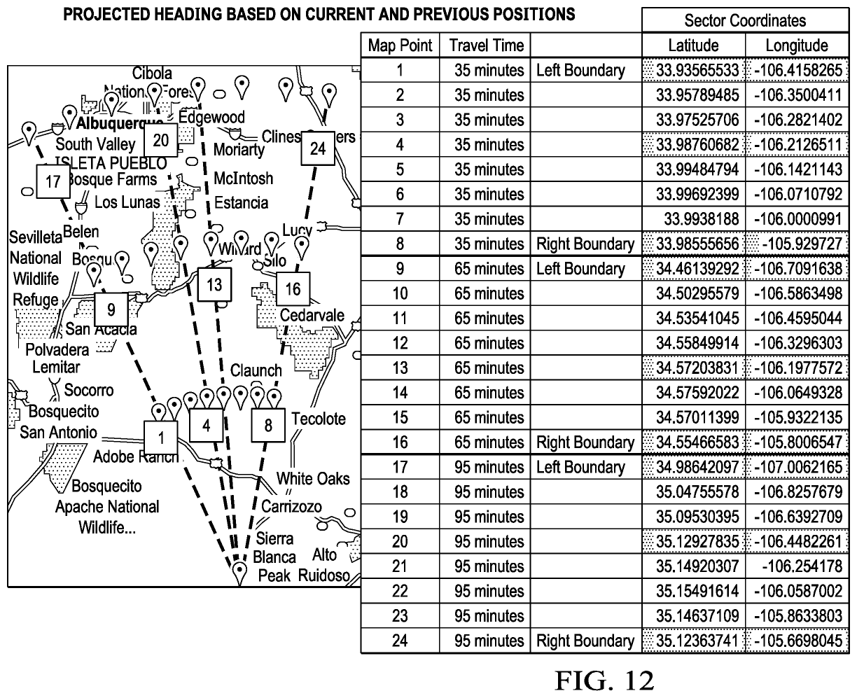

Once a certain CV bearing has been achieved, the goods and services procurement computing system 100 can overlay the predicted travel cone shown in FIG. 8 to the map, as shown in FIGS. 11-12. In the illustrated embodiment, eight map points are distributed across each travel band of the predicted travel cone, which each map point being associated with a latitude and longitude. As shown in the chart in FIG. 12, the coordinates of each of the 24 map points associated with the predicted travel cone is determined by the goods and services procurement computing system 100.

The map points associated with the predicted travel cone can be used by the goods and services procurement computing system 100 to predict the path of travel for the traveler 102. In the illustrated embodiment, nine of the 24 map points are used for this determination. In particular, map points 1, 4, and 8 of the first travel band, map points 9, 13, and 16 of the second travel band, and map points 17, 20 and 24 of the third travel band are utilized.

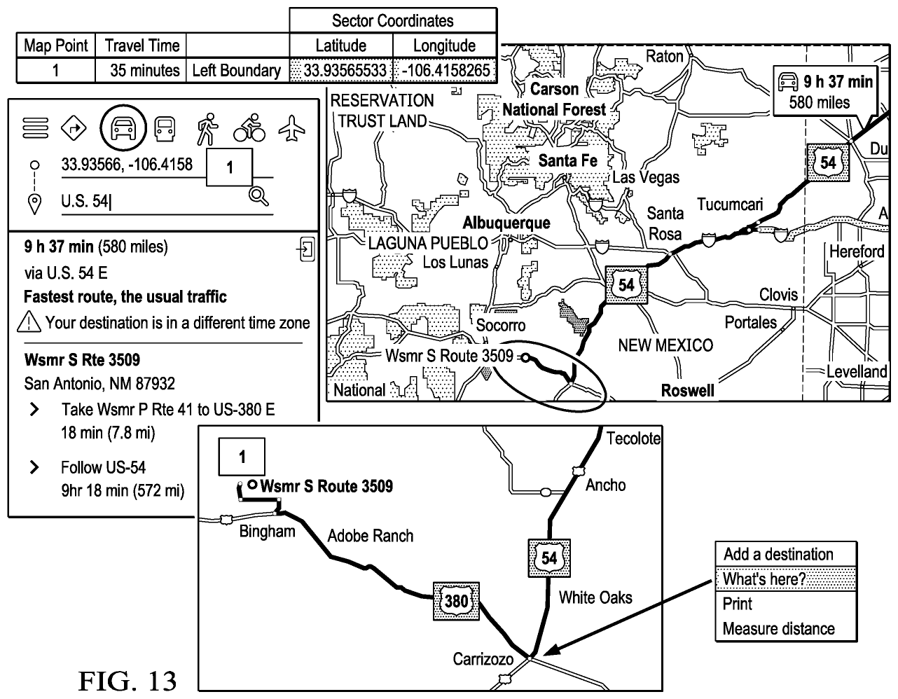

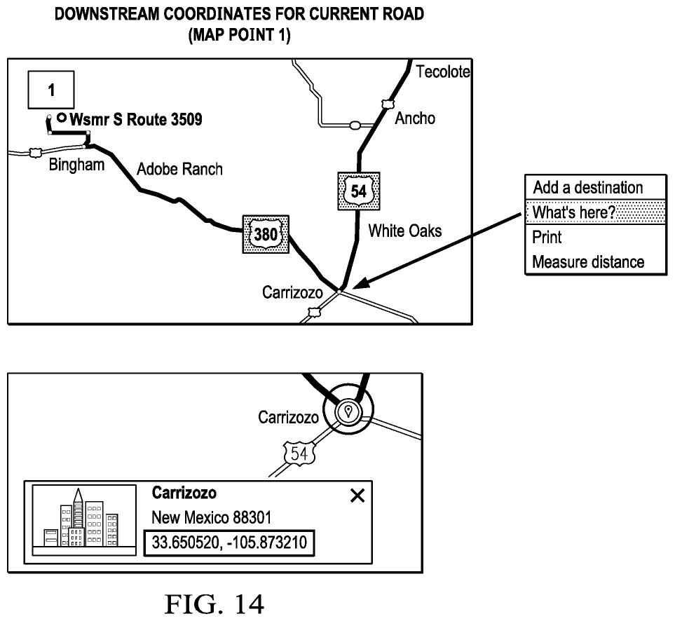

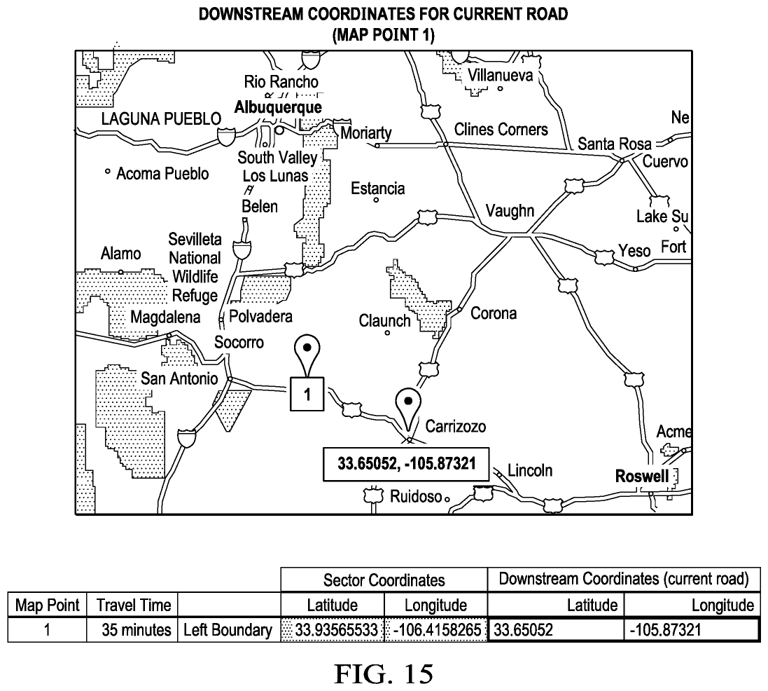

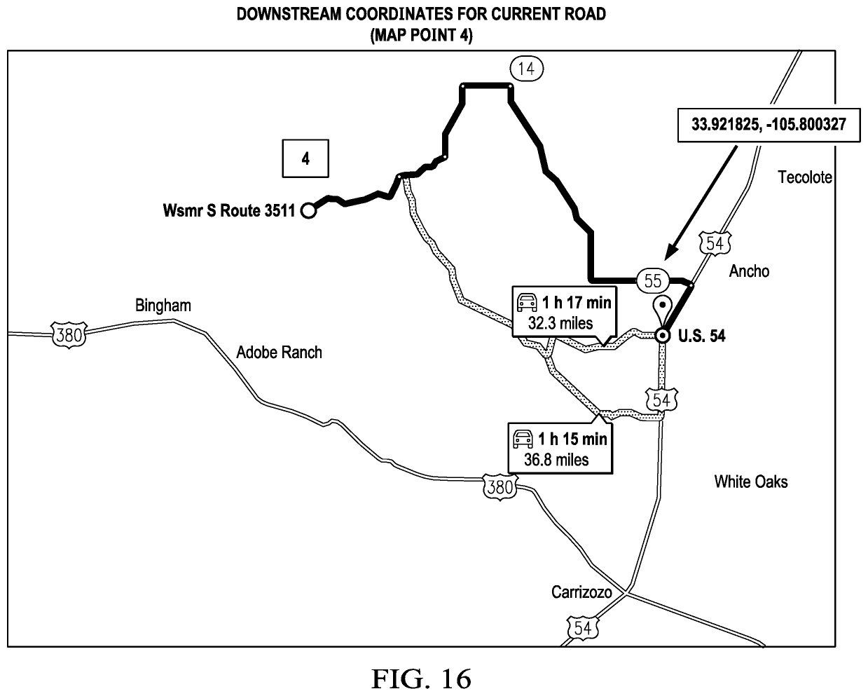

As schematically depicted by FIG. 13, various web services can be used to determine a travel path from map point 1 (lat. 33.93566, long. −106.4158) to the current road of travel (U.S. 54). The point on the map at which the travel path reaches the current road of travel can be logged by the goods and services procurement computing system 100. As shown in FIG. 14, in this embodiment, that point is identified as latitude 33.650520 and longitude −105.873210. These determined coordinates, referred to as “downstream coordinates,” can be logged as for map point 1, as shown in FIG. 15. In some embodiments, downstream coordinates are provided by Google Maps, although this disclosure is not so limited. Similar geographic-based processing can be performed for the other map points by the goods and services procurement computing system 100. FIG. 16, for instance, illustrates the travel path from map point 4 to the current road of travel. Thus, the downstream coordinates associated with map point 4 are latitude 33.921825 and longitude −105.800327.

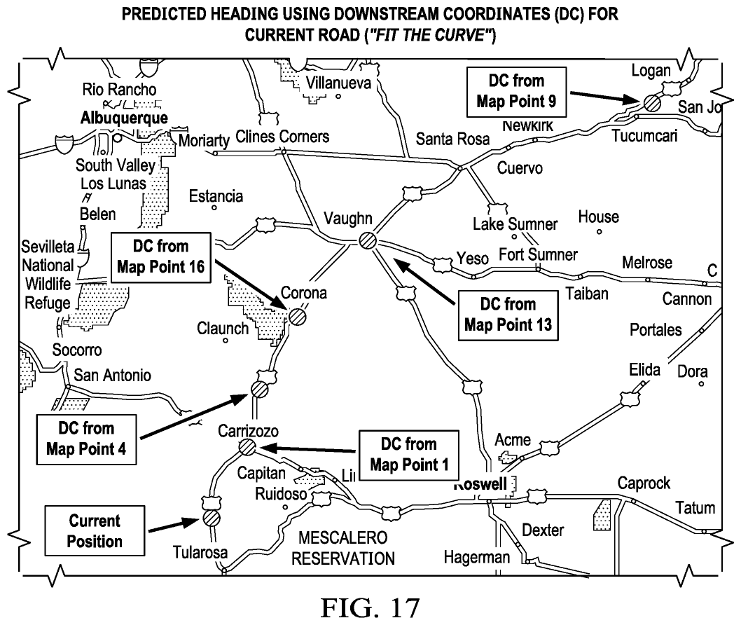

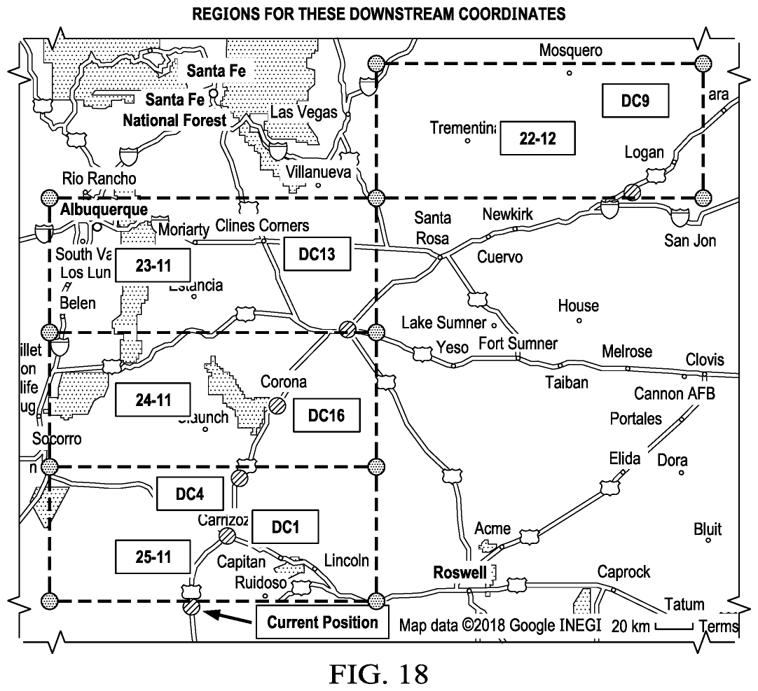

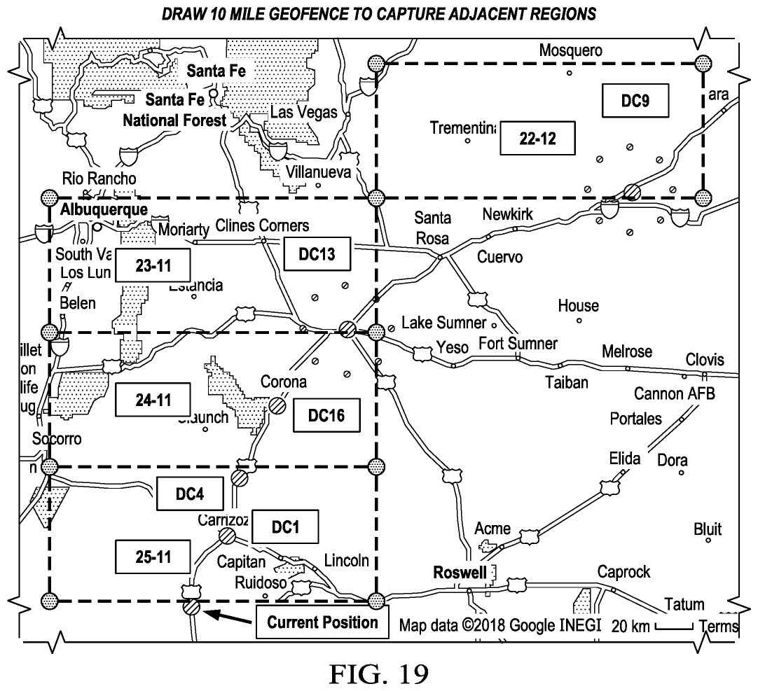

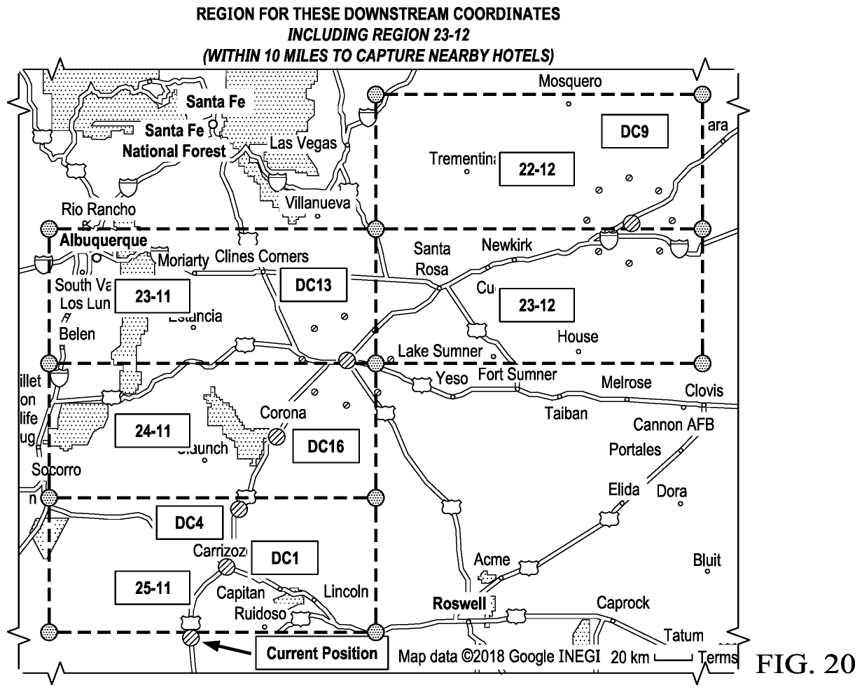

FIG. 17 schematically depicts the predicted heading for the traveler using the downstream coordinates for the current road of travel. Based on the coordinates of these downstream coordinates, the goods and services procurement computing system 100 can then determine which regions of the grid (FIG. 5) are relevant to the traveler 102. FIG. 18 depicts the relevant grids within which each of the downstream coordinates are found. As shown by Region 22-12, however, the downstream coordinate may reside close to the boundary of a particular region (see DC9). As such, hotels that are physically outside that particular region may still be of interest to the traveler 102. FIGS. 19-20 depicts the determination that the downstream coordinate (DC 9) is within a certain threshold distance from the perimeter of the Region 22-12, and therefore, hotels within Region 23-12 have been added for the purposes of determining which hotels may be of interest to the traveler 102. The threshold distance used by the goods and services procurement computing system 100 to determine whether to include adjoining regions can vary, but in some embodiments it is a set distance (i.e., 5 miles) or it is based the “distance” value as provided by the traveler in their traveler profile.

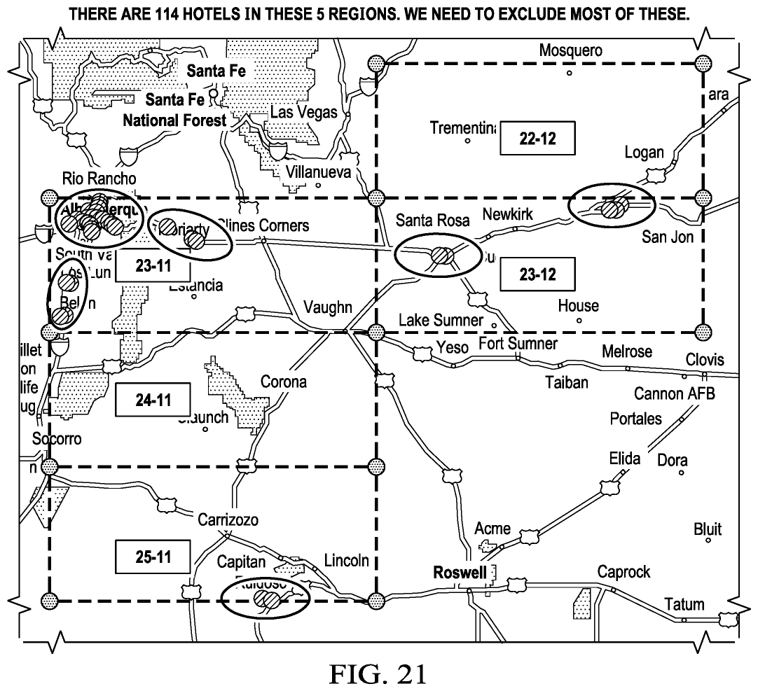

Referring now to FIG. 21, based on the above, the goods and services procurement computing system 100 has determined that Regions 23-11, 24-11, 25-11, 22-12, and 23-12 are pertinent to the particular journey traveler 102. Moreover, as described above with regard to FIG. 6, the goods and services procurement computing system 100 is aware of which hotels are located within each of the regions-of-interest. In the illustrated example, 114 hotels are determined to be within the five regions-of-interest. FIGS. 22A-22B identifies the 16 hotels that are closest to the current road of travel, as many of the hotels are determined to be relatively far from the current road of travel, as described below.

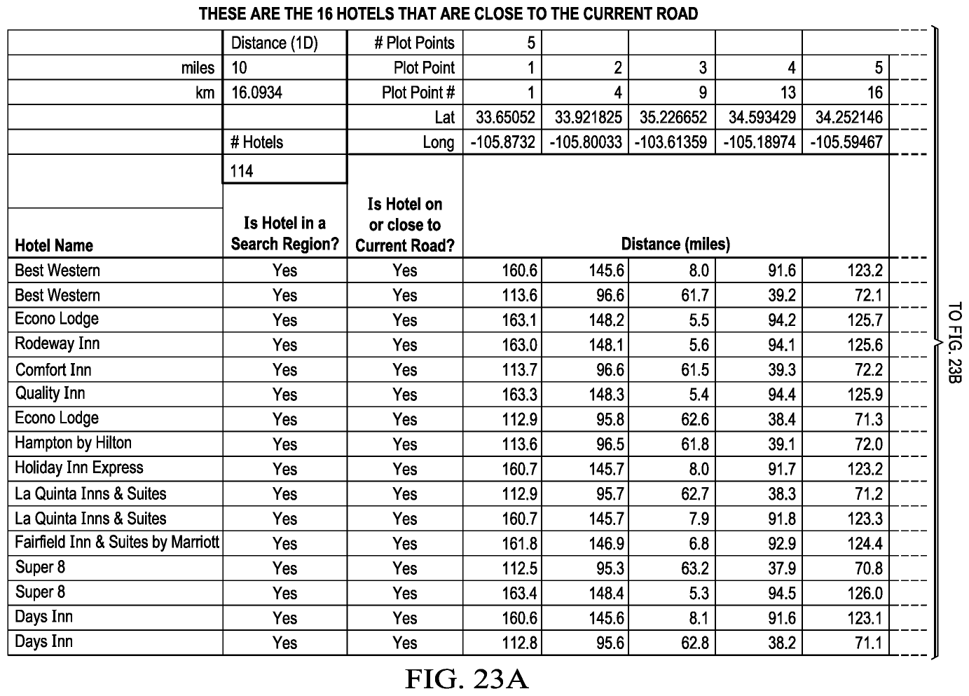

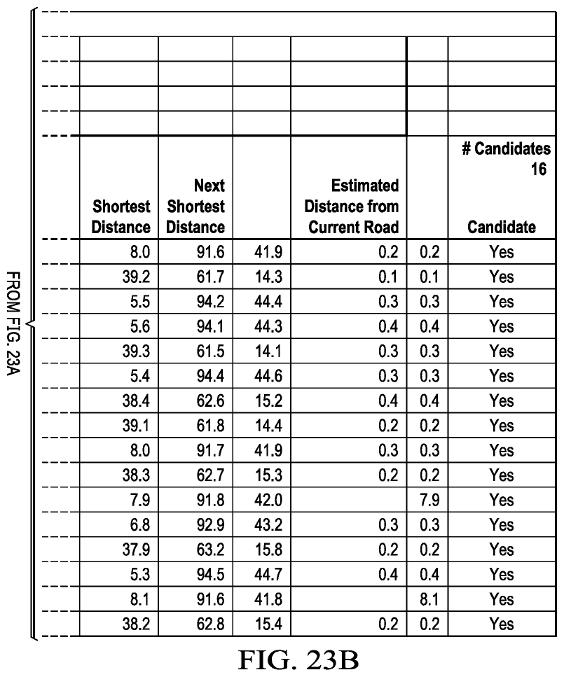

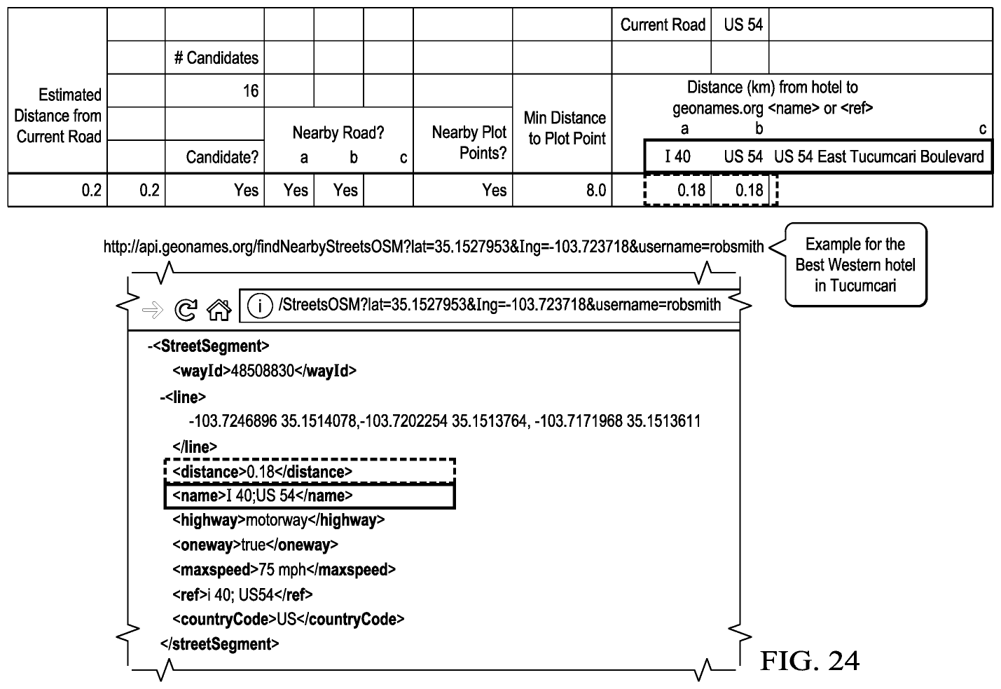

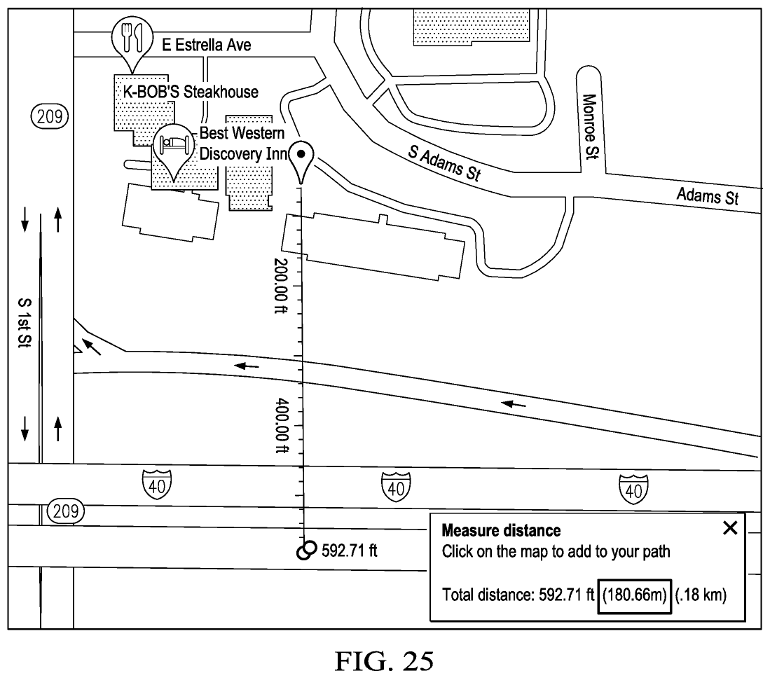

FIGS. 23A-27 depict example processes the goods and services procurement computing system 100 can utilize to determine the closest hotels within the regions-of-interest for the purposes of determining which hotels to present to traveler. FIGA. 23A-23B depict data computed for each of the hotels using data from various sources, such as various web services 134 (FIG. 1). Referring to FIG. 24, example code for an API call to an example web service is produced. In the illustrated example a “FindNearbyStreets” web call to the “Geonames” webservice is depicted, although this disclosure is not so limited. Such API call can be used by the goods and services procurement computing system 100 to determine the distance of the hotel to the nearest street, based on the latitude and longitude of the hotel. As indicated in FIG. 24, for this particular use case, US 54 (which is the current road of travel) is identified as the nearest street from the hotel and it 0.18 km from the hotel. FIG. 25 schematically illustrates the 0.18 km that was returned to the goods and services procurement computing system 100 by the webservice. Similar webservice calls can be performed for each hotel in the identified regions-of-interest to determine their relative proximity to the current road of travel in order to generate the listing shown FIG. 22.

With the universe of hotels relevant to that particular travel identified, the goods and services procurement computing system 100 can then determine the relative rankings of the hotels. First, the hotels which satisfy all of the “musts” are identified. Then, from that grouping, for the hotels that have real-time availability (based on queries from the goods and services procurement computing system 100 to computing systems of the hotel partners 138 (FIG. 1)), the attributes of those hotels can be quantified based on the relative rankings of the “wants” for that traveler. Once the top match is identified, the IVR system 132 can call the mobile communications device 104 (FIG. 1) and provide the details of the hotel to the traveler 102. If the traveler 102 accepts, the goods and services procurement computing system 100 can communicate with the appropriate hotel to complete the booking. Additional travel information, such as hotel address, route, etc., can also be transmitted to the mobile communication device 104 in order to aid in directing the traveler 102 to the hotel property. In some embodiments, the GPS information of the traveler 102 can also be provided by the goods and services procurement computing system 100 to the hotel computing system in order to expedite the check-in process. For instance, when the traveler 102 is known to be within a certain proximity to the hotel property, the hotel can be instructed to place a room key in a designated area for retrieval by the traveler.

FIG. 26 depicts an example process flow diagram of processing performed by a goods and services procurement computing system for a destination traveler. FIG. 27 depicts an example process flow diagram of processing performed by a goods and services procurement computing system for a journey traveler.

While the example above is described in the context of finding hotels for a traveler, the goods and services procurement computing system 100 can be used to quantify and match any suitable goods or services to a traveler. For example, instead of matching hotels, the goods and services procurement computing system 100 can match vehicles that are for sale to the “musts” and “wants” of a traveler. The traveler in the market for a vehicle may indicate in their profile that, for instance, the vehicle “must” be less than 3 years old, be 4-wheel drive, and have a V8 engine. The traveler may indicate that their prioritized list of “wants” include the following attributes: price less than $28,000, truck, Nissan, black, tow package, and 24 inch wheels. As the traveler moves around a geographic area, the goods and services procurement computing system 100 can be alerting the traveler in real-time when a vehicle of interest is nearby. The goods and services procurement computing system 100 can obtain in the information from any suitable source, including querying online search engines, querying dealerships, and so forth.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein.

In various embodiments, modules or software can be used to practice certain aspects of the invention. For example, software-as-a-service (SaaS) models or application service provider (ASP) models may be employed as software application delivery models to communicate software applications to clients or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A non-transitory computer-readable medium may also include memory storage that may be physical, virtual, permanent, temporary, semi-permanent and/or semi-temporary.

A “computer,” “computer system,” “host,” “engine,” or “processor” may be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Any of the servers described herein, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, table layouts, or report formats described herein are necessarily intended to limit the scope of the invention.

In general, it will be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present invention. For example, the embodiments described herein above may be implemented in computer software using any suitable computer programming language such as .NET, SQL, MySQL, or HTML using, for example, conventional or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

Embodiments of the methods and systems described herein may divide functions between separate CPUs, creating a multiprocessing configuration. For example, multiprocessor and multi-core (multiple CPUs on a single integrated circuit) computer systems with co-processing capabilities may be employed. Also, multitasking may be employed as a computer processing technique to handle simultaneous execution of multiple computer programs.

In various embodiments, the systems and methods described herein may be configured and/or programmed to include one or more of the above-described electronic, computer-based elements and components. In addition, these elements and components may be particularly configured to execute the various rules, algorithms, programs, processes, and method steps described herein.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

What is claimed is:

1. A computer-based method, comprising:
storing, by a goods and services procurement computing system, a travel profile for a traveler, wherein the traveler is associated with a mobile communications device in networked communication with the goods and services procurement computing system;
receiving, by the goods and services procurement computing system, a real-time geolocation position of the traveler provided by the mobile communication device of the traveler;
based on one of a current time of day satisfying a time threshold and a real-time proximity of the traveler to a destination point satisfying a distance threshold, determining, by the goods and services procurement computing system, one or more hotel booking options for the traveler based on the travel profile and attributes of each hotel associated with each of the hotel booking options;
providing, by the goods and services procurement computing system, the one or more hotel booking options to the traveler via mobile communications device; and
upon receiving an acceptance from the traveler for one of the hotel booking options, completing, by the goods and services procurement computing system, a booking of a hotel reservation at the associated hotel on behalf of the traveler.

2. The computer-based method of claim 1, wherein the traveler is one of a journey traveler and a destination traveler.

3. The computer-based method of claim 2, wherein the determining of the one or more hotel booking options for the journey traveler is based on the current time of day satisfying the time threshold and the one or more hotel booking options for the destination traveler are based on the real-time proximity of the traveler to the destination point satisfying the distance threshold.

4. The computer-based method of claim 1, wherein the travel profile comprises a plurality of prioritized traveler preferences.

5. The computer-based method of claim 1, wherein the plurality of prioritized traveler preferences comprise at least one required traveler preference and least one preferred traveler preference.

6. The computer-based method of claim 1, wherein providing the one or more hotel booking options to the traveler via mobile communications device comprises providing the one or more hotel booking options to the traveler via an automated telephone call to the mobile communications device.

7. The computer-based method of claim 6, wherein the one or more hotel booking options are automatically provided to the traveler via the mobile communications device automatically based on one of the current time of day satisfying the time threshold and the real-time proximity of the traveler to the destination point satisfying the distance threshold

8. The computer-based method of claim 1, further comprising:
querying, by the goods and services procurement computing system, hotel booking computing systems associated with one or more hotel properties to assess real-time booking availability.

9. The computer-based method of claim 7, wherein hotels to include in the one or more hotel booking options provided to the traveler via mobile communications device are determined by the goods and services procurement computing system based on hotel attributes and the travel profile for a traveler.

10. A computer-based system, comprising:
a goods and services procurement computing system comprising computer-readable medium having computer-executable instructions stored thereon, the computer-executable instructions configured to instruct one or more computer processors to perform the following operations:
store a travel profile for a traveler, wherein the traveler is associated with a mobile communications device in networked communication with the goods and services procurement computing system;
receive a real-time geolocation position of the traveler provided by the mobile communication device of the traveler;
based on one of a current time of day satisfying a time threshold and a real-time proximity of the traveler to a destination point satisfying a distance threshold, determine one or more hotel booking options for the traveler based on the travel profile and attributes of hotels associated with the hotel booking options;
provide the one or more hotel booking options to the traveler via mobile communications device; and
upon receiving an acceptance from the traveler for one of the hotel booking options, complete a booking of a hotel reservation at the associated hotel on behalf of the traveler.

11. The computer-based system of claim 10, wherein the traveler is one of a journey traveler and a destination traveler.

12. The computer-based system of claim 11, wherein the determining of the one or more hotel booking options for the journey traveler is based on the current time of day satisfying the time threshold and the one or more hotel booking options for the destination traveler are based on the real-time proximity of the traveler to the destination point satisfying the distance threshold.

13. The computer-based system of claim 10, wherein the travel profile comprises a plurality of prioritized traveler preferences.

14. The computer-based system of claim 10, wherein the plurality of prioritized traveler preferences comprise at least one required traveler preference and least one preferred traveler preference.

15. The computer-based system of claim 10, wherein providing the one or more hotel booking options to the traveler via mobile communications device comprises providing the one or more hotel booking options to the traveler via an automated telephone call to the mobile communications device.

16. The computer-based system of claim 15, wherein the one or more hotel booking options are automatically provided to the traveler via the mobile communications device automatically based on one of the current time of day satisfying the time threshold and the real-time proximity of the traveler to the destination point satisfying the distance threshold

17. The computer-based system of claim 10, wherein the instructions further configure the one or more computer processors to perform the following operation:
query hotel booking computing systems associated with one or more hotel properties to assess real-time booking availability.

18. The computer-based system of claim 16, wherein hotels to include in the one or more hotel booking options provided to the traveler via mobile communications device are determined by the goods and services procurement computing system based on hotel attributes and the travel profile for a traveler.

19. A computer-based method, comprising:
defining, by a goods and services procurement computing system, a plurality of geolocation regions, wherein the geolocation regions collectively cover a geographic region of interest;
for each of the plurality of geolocation regions, determine, by the goods and services procurement computing system, a listing of hotels located within the respective geolocation region;
storing, by the goods and services procurement computing system, a travel profile for a traveler, wherein the traveler is associated with a mobile communications device in networked communication with the goods and services procurement computing system;
receiving, by the goods and services procurement computing system, a real-time geolocation position of the traveler provided by the mobile communication device of the traveler, wherein the traveler is traveling within the geographic region of interest;
determining, by the goods and services procurement computing system, a predicted location of the traveler at a future time;
identifying, by the goods and services procurement computing system, a predicted geolocation region from the plurality of geolocation regions based on the predicted location of the traveler at the future time;
providing, by the goods and services procurement computing system, one or more hotel booking options to the traveler via mobile communications device, wherein the one or more hotel booking options are based on the listing of hotels for the predicted geolocation region and the travel profile of the traveler; and
upon receiving an acceptance from the traveler for one of the hotel booking options, completing, by the goods and services procurement computing system, a booking of a hotel reservation at the associated hotel on behalf of the traveler.

20. The computer-based method of claim 19, wherein determining the predicted location of the traveler at the future time comprises:
identifying, by the goods and services procurement computing system, a current road of travel based on the real-time geolocation position of the traveler provided by the mobile communication device of the traveler;
determining, by the goods and services procurement computing system, a predicted distance of travel based on a rate of speed of the traveler;
determining, by the goods and services procurement computing system, at plurality of predicted downstream coordinates of the traveler based on the current road of travel, the predicted distance of travel, and a bearing of the traveler; and
determine, by the goods and services procurement computing system, within which of the plurality of geolocation regions the plurality of predicted downstream coordinates are located, wherein at least on for the predicted downstream coordinates is located within the predicted geolocation region.
